(19) United States
(12) Patent Application Publication
(10) Pub. No.: US 2017/0159979 A1
(43) Pub. Date: Jun. 8, 2017

(54) High Porosity Particulate Beds Structurally Stabilized by Epoxy

(71) Applicant: Astronautics Corporation of America, Milwaukee, WI (US)

(72) Inventors: Leonard Joseph Komorowski, Cottage Grove, WI (US); John Paul Leonard, Cambridge, WI (US); Steven Lee Russek, Glendale, WI (US); Steven Alan Jacobs, Madison, WI (US); Carl Bruno Zimm, Madison, WI (US)

(21) Appl. No.: 15/434,340

(22) Filed: Feb. 16, 2017

Related U.S. Application Data
(62) Division of application No. 14/471,531, filed on Aug. 28, 2014, now abandoned.
(60) Provisional application No. 61/876,297, filed on Sep. 11, 2013.

(51) Int. Cl. F25B 21/00; B29C 39/00

(52) U.S. Cl. CPC F25B 21/00; B29C 39/003; F25B 2321/002; F25B 2321/0022; B29K 2063/00

(57) ABSTRACT

The present invention provides a porous thermal regenerator apparatus and method of making a porous thermal regenerator comprised of metallic or intermetallic particles that are held together in a porous three dimensional network by a binding agent (such as epoxy). One aspect of the apparatus is that the porosity of the porous thermal regenerator is greater than the tapped porosity of the particles comprising the porous thermal regenerator; moreover, the high-porosity apparatus is durable, that is, it remains intact when exposed to strong time-varying magnetic forces while immersed in aqueous fluid. This high porosity, when combined with high strength and aqueous heat transfer fluid stability, leads to improved porous thermal regenerators and concomitantly to magnetic refrigerators with improved performance.

### CROSS REFERENCE TO RELATED APPLICATION

This application is a divisional application of U.S. application Ser. No. 14/471,531, filed Aug. 28, 2014, which claims priority to U.S. provisional application Ser. No. 61/876,297, filed Sep. 11, 2013, whereby the entire contents of both are incorporated herein by reference.

### STATEMENT REGARDING FEDERALLY SPONSORED RESEARCH OR DEVELOPMENT

This invention was made with government support under DE-AR0000128 awarded by the U.S. Department of Energy. The government has certain rights in this invention.

### BACKGROUND OF THE INVENTION

The present invention relates to an apparatus and method of making a porous thermal regenerator comprised of metallic or intermetallic particles that are connected by a binding agent. Porous thermal regenerators produced by this method have high porosity while maintaining high strength and stability in aqueous solutions. Porous thermal regenerators produced by this method are of particular utility when used as active magnetic regenerators (AMRs) which experience the reciprocating flow of aqueous heat transfer fluids and large magnetic forces arising from magnetic field cycling.

Magnetic refrigeration is a cooling technology based on the magnetocaloric effect. The magnetocaloric effect is an intrinsic property of magnetic materials near their magnetic ordering temperature (e.g. Curie temperature, Tc, for ferromagnets). In the case of a ferromagnet, such as Gadolinium, it is the reduction in entropy as the magnetic moments of the atoms are aligned upon application of a magnetic field and the increase of entropy when the magnetic moments become randomly oriented on removing the field which lead respectively, under adiabatic conditions, to an increase or decrease in the material's temperature (adiabatic temperature change, ΔT_{ad}). Gadolinium, a typical magnetocaloric material (MCM) has a maximum ΔT_{ad} of 2.5 C at the Curie temperature in a 1 Tesla field. The Curie temperature, and thus the temperature of the peak ΔT_{ad}, may be moved by adjusting the magnetocaloric material composition. For example, the Curie temperature of a Gadolinium-Erbium solid solution may be varied by varying the Gadolinium/Erbium ratio. Modern room-temperature magnetic refrigeration (MR) systems may employ, an Active Magnetic Regenerator (AMR) cycle to perform cooling. An early implementation of the AMR cycle can be found in U.S. Pat. No. 4,332,135, the entire disclosure of which is incorporated herein by reference. The AMR cycle has four stages, as shown schematically in FIGS. 1a to 1d. The MR system in FIGS. 1a to 1d includes a porous bed of magnetocaloric material (MCM) 190 and a heat transfer fluid, which exchanges heat with the MCM as it flows through the MCM bed 190. In FIGS. 1a to 1d, the left side of the bed is the cold side, while the hot side is on the right. In alternative embodiments, the hot and cold sides may be reversed. The timing and direction (hot-to-cold or cold-to-hot) of the fluid flow may be coordinated with the application and removal of a magnetic field. The magnet field may be provided by either a permanent magnet, electromagnet, or superconducting magnet.

In an illustrative example of an AMR cycle, FIG. 1a, the first stage of the cycle, “magnetization,” occurs. While the fluid in the MCM bed 190 is stagnant, a magnetic field 192 is applied to the MCM bed 190, causing it to heat. In the magnetization stage shown in FIG. 1a, four valves shown are all closed, preventing fluid flow through the MCM bed 190. The four valves include a cold inlet valve 182, a cold outlet valve 184, a hot outlet valve 186, and a hot inlet valve 188, In FIG. 1b, the second stage of the cycle, “cold-to-hot-flow” occurs. The magnetic field 192 over the MCM bed 190 is maintained, and fluid at a temperature T_{Ci} (the cold inlet temperature) is pumped through the MCM bed 190 from the cold side to the hot side. The cold inlet valve 182 and hot outlet valve 186 are open during this stage to facilitate movement of the fluid through the MCM bed 190. The cold outlet valve 184 and the hot inlet valve 188 are closed during this stage. The fluid removes heat from each section of the MCM bed 190, cooling the MCM bed 190 and warming the fluid as it passes to the next section of the MCM bed 190, where the process continues at a higher temperature. The fluid eventually reaches the temperature T_{Ho} (the hot outlet temperature), where it exits the MCM bed 190 through the hot outlet valve 186. Typically, this fluid is circulated through a hot side heat exchanger (HHEX) 194, where it exhausts its heat to the ambient environment. In FIG. 1c, the third stage, “demagnetization”, occurs. The fluid flow is terminated when the cold inlet valve 182 and the hot outlet valve 186 are closed and the magnetic field 192 is removed. The cold outlet valve 184 and the hot inlet valve 188 are also closed during this stage. This causes the MCM bed 190 to cool further. In FIG. 1d, the final stage of the cycle, “hot-to-cold-flow”, occurs. Here, fluid at a temperature T_{Hi} (the hot inlet temperature) is pumped through the MCM bed 190 from the hot side to the cold side in the continued absence of the magnetic field 192. In this stage, cold outlet valve 184 and hot inlet valve 188 are open, while cold inlet valve 182 and hot outlet valve 186 are closed. The fluid adds heat to each, section of the MCM bed 190, warming the MCM bed 190 and cooling the fluid as it passes to the next section of the MCM bed 190, where the process continues at a lower temperature. The fluid eventually reaches a temperature T_{Co} (the cold outlet temperature) which is the coldest temperature reached by the fluid in the cycle. Typically, this colder fluid is circulated through a cold side heat exchanger (CHEX) 196, where it picks up heat from the refrigerated system, allowing this system to maintain its cold temperature.

As shown schematically in FIG. 2, the MCM bed 190 is mounted within an MR system as shown in a refrigeration system 200. As understood in the art, the refrigeration system 200 incorporates a fluid tank 202 in communication with a pump 204 for circulating the heat transfer fluid. The heat transfer fluid flows through the porous bodies of the MEM beds 190 and chills as the fluid contacts the low temperature MCM beds 190 created during the “demagnetization” phase shown in FIG. 1c. The chilled fluid exits the beds 190 and cools a cold side heat exchanger (CHEX) 196 where it absorbs heat from the refrigeration system 200. The heated transfer fluid again flows through the porous bodies of the MCM beds 190 and heats as the fluid contacts the high temperature MCM beds 190 created during the “magnetization” phase shown in FIG. 1a. The high temperature beds 190 are magnetized by a magnetic field 192 that is created by a permanent magnet 206. The heat that is absorbed by the fluid from the MCM beds 190 is finally exhausted into the ambient environment by a hot side heat exchanger (HUEX) 194. The fluid then returns to the fluid tank 202 and pump 204 to be re-circulated.

A major advantage of the AMR cycle is noted in K. L. Engelbrecht, G. F Nellis, S. A Klein, and C. B. Zimm, Recent Developments in Room Temperature Active Magnetic Regenerative Refrigeration, HVAC&R Research, 13 (2007) pp. 525-542 (hereinafter “Engelbrecht et al.”), the entire disclosure of which is incorporated herein by reference. The advantage is that the span (the temperature at which the heat is exhausted minus the temperature at which heat is absorbed) can be much larger than the absolute value of the temperature change of the magnetocaloric material when the magnetic field is applied (the adiabatic temperature change, ΔT_{ad}).

As discussed previously, in a magnetic refrigeration system using AMR, heat transfer occurs between the solid magnetocaloric material in the form of a porous body and a heat transfer fluid that flows through the porous body. The heat transfer fluid also absorbs heat from the environment to be cooled, and transfers that heat to a warmer ambient. In order to conduct the heat transfer efficiently, the magnetocaloric material must have a large surface area in contact with the fluid for heat transfer, and the fluid passages in the porous body must have low impedance to fluid flow.

Many magnetocaloric materials involve phases or compositions that can be realized by rapid solidification, solid state reaction, or powder processing. These methods generally yield particulate materials. These particles can have regular shapes such as spheres, ellipsoids, or short cylinders. Particles can also be irregularly shaped, such as non-spherical, non-regular polyhedra, or particles including convex and concave random surfaces, such as particles resulting from crushing, media milling, jet milling, or grinding processes. These particles can be assembled into porous thermal regenerator beds through which heat transfer fluids may be pumped. Two important morphological parameters of particle-based thermal regenerators are the particle size and the porosity. The particle size determines the wetted surface area. The particle size, particle shape and means of connecting, the particles largely characterize the size of passages or pores through which the fluid passes. The porosity is defined as the fractional free volume available for infiltration by the heat transfer fluid. Increasing the porosity of a bed typically increases the size of the pores.

Convective heat transfer, specifically under the high frequency reciprocating flow found in AMR systems, improves as particle size is decreased; the smaller particles have a higher surface area to volume ratio which promotes heat transfer from the particle to the heat transfer fluid. Pore size, however, decreases, as particle size is decreased, which typically increases the frictional flow loss. This detrimental effect can be offset by increasing the porosity to increase overall free volume available for the fluid and increase pore or flow passage size.

At the cooling power densities, floss rates, and frequencies typical of AMR systems, optimum heat transfer is found in porous thermal regenerator beds comprised of small particles, 100 micron or smaller and, preferably 75 micron or smaller, arranged in a uniform highly porous structure, with greater than 40 percent porosity and preferably greater than 50 percent porosity. Such a high porosity has been difficult to achieve, especially when high strength and stability in changing magnetic fields and aqueous heat transfer fluids are also required. In the case of monodisperse particles that are nominally spherical, obtained, for example, by sieving between successive standard sieve sizes, a porosity range of 36 to 38 percent is understood to be practically achievable. When beds are packed using processes similar to those used when determining tapped density (e.g., tapping, dropping, or vibrating a structure that encloses free particles), which are representative of processes for obtaining homogenous porosity during thermal regenerator bed fabrication, the porosity is typically close to the random close packed porosity value of 36 percent. In the case of nominally monodisperse irregular particles, obtained, for example, by sieving between successive standard sieve sizes, the porosity range when packed is a complex function of particle shape. Particle shape is often characterized by roundness and sphericity. Typically porosity decreases as sphericity and roundness increase. When packed using processes similar to those used when determining tapped density (e.g. tapping, dropping, or vibrating a structure that encloses free particles), which are representative of processes for obtaining homogenous porosity during thermal regenerator bed fabrication, the porosity reaches a minimum at the tapped density. Exceeding this practical limit is difficult, as particles comprising the porous bed must be adequately contained during fluid flow. Loose particles must be confined mechanically, with screens or other membranes to allow fluid entry and exit. Problems with flow impedance in the screens or membranes, particle escape, or particle movement and wear during operation (which may also remove the passivating layer formed by an anti-corrosion additive to the heat transfer fluid and therefore accelerate corrosion) are all common problems in this approach. Many magnetocaloric materials are also brittle, in which case particle movement under reciprocating fluid flow or time dependent magnetic forces may lead to formation of fragments that clog the screens, and eventually lead to extensive disintegration of the particles. Fixtures to enable mechanical confinement also occupy space within the bed volume, space that would be better utilized (in terms of refrigeration performance) by magnetocaloric material. In addition, mechanical confinement becomes especially difficult to achieve for regenerators formed from multiple, thin layers of materials with different magnetocaloric properties. Magnetic refrigerators utilizing such regenerators offer significantly improved performance and economics compared to un-layered regenerators.

To overcome the problems associated with mechanical particle confinement, one approach uses an epoxy resin to bond particles into a rigid porous structure. The main advantage here is that regenerator beds can be formed as free-standing shapes that are easily incorporated in AMR systems. In this method, loose particles are packed in a mold, then, flooded with a low-viscosity solvent-diluted epoxy. Excess epoxy is flushed out with solvent and pressurized gas. Upon curing, the structure becomes rigid, with all particles locked into their original positions. This approach can be seen as an effective method to mechanically restrain particles in a packed bed configuration, but does not address the need for higher porosities. With spherical particles, the porosity is still typically limited to the range 34 to 39 percent (structures made with this process tend to have even lower porosity because the epoxy fills a portion of the pore volume). As a subtractive process, the porous structure is realized only when the excess epoxy and solvent are removed. With small particles, which are advantageous for use in AMR systems, this removal becomes increasingly difficult because the pore sizes are smaller, making it more difficult to force out the excess epoxy-solvent mixture. Additional solvents and diluents can be used to further thin adhesives, but their selection must be carefully made, and incomplete removal can result in decreased cohesive strength of the resin, and can also degrade the interfacial adhesive strength, resulting in a weak structure. For these reasons, the solvent-diluted process is not presently able to produce particulate beds of sufficient strength and porosity to be of use in modern AMR systems.

### SUMMARY OF THE INVENTION

The present invention provides a porous thermal regenerator apparatus and method of making a porous thermal regenerator comprised of metallic or intermetallic particles that are held together in a porous three dimensional network by a binding agent (such as epoxy). One aspect of the apparatus is that the porosity of the porous thermal regenerator is greater than the tapped porosity of the particles comprising the porous thermal regenerator; moreover, the high-porosity apparatus is durable, that is, it remains intact when exposed to strong time-varying magnetic forces while immersed in aqueous fluid. This high porosity, when combined with high strength and desirable aqueous heat transfer fluid capability, leads to improved porous thermal regenerators and concomitantly to magnetic refrigerators with improved performance. In contrast to the previous subtractive method, this invention can be viewed as an additive process, in which a precise amount of binding agent is added to the particles in order to form uniform and strong attachments between particles.

In one embodiment, a thermal regenerator apparatus has one or more layers of substantially spherical magnetocaloric particles held together by a binding agent in a solid agglomeration providing a flow channel through the substantially spherical magnetocaloric particles wherein the ratio of the average porosity of the thermal regenerator apparatus to the tapped porosity of unbound particles comprising, the thermal regenerator apparatus is at least 1.05 and the average porosity of the thermal regenerator is at least 40%. The substantially spherical magnetocaloric particles may have an average diameter of between 5 microns and 100 microns.

It is thus a feature of at least one embodiment of the invention for the moldable porous mass and the resulting rigid three dimensional structure obtained after hardening to support much higher porosities than were previously achievable. This is accomplished by using substantially spherical magnetocaloric particles whose shape allows for the desired flow channels between pores for heat transfer fluid and the desired surface area for binding the particles with binding agent.

The solid agglomeration may have a first surface and an opposed second surface through which a fluid can flow where the porosity of the layers increases from the first surface to the second surface.

The solid agglomeration may have a first surface and an opposed second surface through which fluid can flow and where the thickness of the layers increases from the first surface to the second surface.

It is thus a feature of at least one embodiment of the invention to create layers of uniform porosity whereby the layers are stacked to create a solid agglomeration.

The binding agent may be an epoxy resin.

It is thus a feature of at least one embodiment of the invention for the binding agent to achieve the desired high porosity. High porosity may be achieved from the sticky and viscous nature of the binding agent, which prevents settling of the particles even while the mass is handled and molded.

The substantially spherical magnetocaloric particles may consist of at least two different magnetocaloric materials.

In one embodiment, a thermal regenerator apparatus has one or more layers of magnetocaloric particles held together by a binding agent in a solid agglomeration providing a flow channel through the magnetocaloric particles wherein the ratio of the average porosity of the thermal regenerator apparatus to the tapped porosity of unbound particles comprising the thermal regenerator apparatus is at least 1.05 and the average porosity of the thermal regenerator is at least 45%.

In one embodiment, a method of fabricating a thermal regenerator having one or more layers is taught. The method includes the steps of (a) mixing a plurality of magnetocaloric particles with a binding agent to form a moldable porous mass. Then, (b) transferring a predetermined weight of the moldable porous mass to a mold and (c) distributing the moldable porous mass to fill a cross-section of the mold such that the moldable porous mass extends to a substantially constant predetermined height within the mold defining a desired volume to form a layer. Then, (d) repeating steps (a)-(e) with the same or different magnetocaloric particles, and a second predetermined weight of moldable porous mass and a second predetermined height within the mold until a desired number of layers is formed. Lastly, (e) allowing the binding agent to harden within the mold to form a hardened mass.

It is thus a feature of at least one embodiment of the invention for the method to provide a thermal regenerator having substantially uniform porosity by building the mold in layers having uniform porosity.

An organosilane film may be applied to the plurality of particles before step (a).

It is thus a feature of at least one embodiment of the invention to promote adhesion between the binding agent and the particle surface.

Step (a) may be preceded by the following steps. First, agitating the plurality of magnetocaloric particles while in contact with an aqueous detergent solution. Then, filtering the aqueous detergent solution from the particles. Lastly, rinsing and filtering the aqueous detergent solution from the particles. Agitating may be accomplished by ultrasonic agitation.

Step (a) may be preceded by the following steps. First, agitating the plurality of magnetocaloric particles while in contact with a non-aqueous solvent. Then, filtering the non-aqueous solvent from the particles. Lastly, rinsing and filtering the non-aqueous solvent from the particles. Agitating may be accomplished by ultrasonic agitation.

It is thus a feature of at least one embodiment of the invention to improve bond strength by adding the undiluted binding agent to dry particles, with surfaces carefully prepared through cleaning and/or chemical modification, leading to a more durable three dimensional structure, even in water.

The following steps may be completed between steps (a) and (b). Clusters may be formed of particles from the moldable porous mass. Then, the clusters of particles may be collected and a secondary binding agent may be added to form a new moldable mass.

It is thus a feature of at least one embodiment of the invention to provide clusters that are connected in order to increase porosity by preventing the mass from settling.

In one embodiment, a method of fabricating a thermal regenerator having one or more layers is taught. The method includes the steps of (a) mixing a plurality of magnetocaloric particles and a binding agent to form a porous mass; (b) forming clusters of particles from the porous mass; and (c) collecting the clusters of particles and adding, secondary binding agent to form a new porous mass.

It is thus a feature of at least one embodiment of the invention to more easily form high porosity beds on a larger scale and to achieve higher porosity structures.

The clusters of particles of step (b) may be tot lied by tape casting the porous mass at a predetermined thickness and at least partially curing the clusters such that the partially cured clusters of particles substantially retains its configuration. The porous mass may be tape casted at a thickness of two particle diameters.

These particular objects and advantages may apply to only some embodiments falling within the claims and thus do not define the scope of the invention.

### BRIEF DESCRIPTION OF THE DRAWINGS

FIGS. 1a-1d is a schematic illustrating an Active Magnetic Regenerator (AMR) cycle to perform cooling;

FIG. 2 is a schematic illustration of a magnetic refrigerator (MR) utilizing Active Magnetic Regeneration (AMR) within a refrigeration system;

FIG. 3 is a flowchart, according to the present invention, illustrating the principal processing steps relating to particle preparation, addition of binding agents, and forming;

FIG. 4 is a schematic illustration of the process of distributing the moldable porous mass into the mold at a predetermined height (h1, h2, h3, etc.) creating a layer, and repeating the process until the desired number of layers is achieved;

FIG. 5 is a schematic illustration of cluster assembly formed by the methods described herein where (a) small clusters are formed after curing and break-up of a sheet, with clusters being bound together by small necks composed of binding agent, and (b) a high porosity structure is formed from clusters after the addition of secondary binding agent;

FIG. 6 is a schematic illustration of a rigid porous structure, composed of spherical particles bonded together by following the methods described herein;

FIG. 7 is a graphical representation of scratch hardness connected beds of LaFeSi spheres prepared by various techniques;

FIG. 8 is a graphical representation of hardness parameter Hₑ₀ [m²·sec/kg] for several example beds produced by different epoxy connection methods;

FIG. 9 is a graphical representation of steady state pressure drop versus flow rate for two beds constructed using Method II described herein; and

FIG. 10 is a flowchart, according to one embodiment of the present invention, illustrating the technique of tape casting the particles to form layers, which are stacked to form a structure from which multiple bed units can be prepared.

### DETAILED DESCRIPTION OF THE INVENTION

### 1. Processing Steps

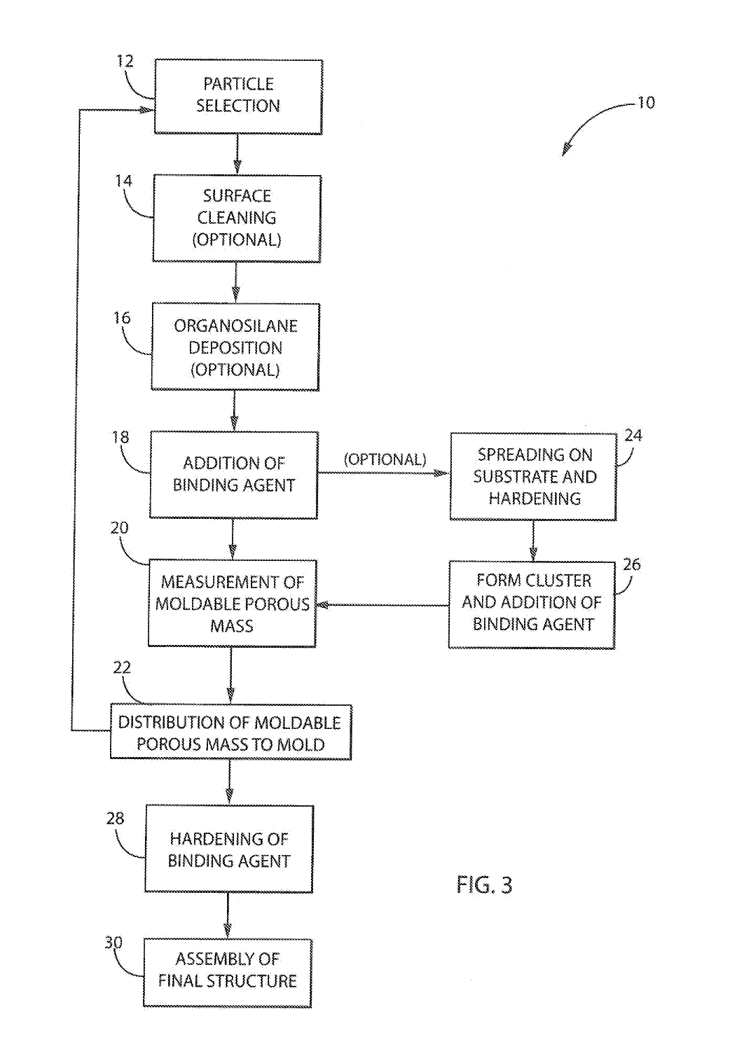

Referring to the flowchart of FIG. 3, a method 10 for production of a porous thermal regenerator apparatus and method of making a porous thermal regenerator is indicated as a process of steps. The invention utilizes several principal processing steps relating to particle preparation, addition of binding agents, and forming. Specifically these processing steps include:

### 1.1. Particle Selection

As indicated by process block 12, particles are selected based on shape and size optimized for the application, such as use in AMR systems, by system design techniques outside the scope of this invention. The method has been optimized for smooth, substantially spherical intermetallic particles, but it is understood that other shapes and materials can also be used.

For use in an AMR system, the thermal regenerator apparatus described herein will generally be fabricated from particles of a magnetocaloric material. These materials include, but are not limited to Gd and alloys made from Gd, La(Fe,Si)₁₃H_{y}, La(Fe,Mn)Si)₁₃H_{y}, La((Fe,Co),Si)₁₃, (Mn,Fe)(P,As), (Mn,Fe)(P,Si), and (Mn,Fe)(P,Ge).

### 1.2. Surface Cleaning

As indicated by process block 14, to prepare the particles for bonding it may be useful to employ a surface cleaning process. One such desirable process involving multiple cleaning steps is comprised of agitating the particles in an aqueous detergent(s) followed by agitating the particles in non-aqueous solvent(s). It is preferred that the agitation step uses ultrasonic agitation. Rinsing and filtration steps, and possibly drying, are also used. These steps produce a clean particle surface that can form strong adhesive bonds with binding agents, such as epoxy, and an adhesion agent, such as organosilane.

### 1.3. Organosilane Deposition

As indicated by process block 16, in some cases, particles may be coated with an organosilane, which acts as an adhesion promoter between the binding agent and the particle surface. By optimizing the organosilane and the deposition conditions, it is possible to measurably improve the strength of the rigid bed structure, particularly when the structure is subjected to water exposure. This property will enhance the long-term durability in AMR systems that use reciprocating aqueous fluid flow and magnetic field cycling.

### 1.4. Addition of Binding Agent

As indicated by process block 18, a binding agent is added to the particles, then the particles and the binding agent are thoroughly mixed to form a moldable porous mass. It is generally advantageous to use the minimum amount of binding agent that achieves the desired strength in the finished apparatus. In one embodiment, the weight ratio of the binding agent to particles may be no larger than about 2%.

### 1.5. Forming

Porosity is defined as the ratio of the volume of void-space to the total or bulk volume of the material (including the solid and void volumes). The pore volume can be determined by flooding the mold volume with, e.g., fluid, and measuring the mass and calculating the volume of the fluid occupying the void-space.

As indicated by process block 20, porosity can be controlled by precise measurement of the added mass, e.g., by weight, to be used to fill a given mold volume to be occupied. For example, by reducing the amount of the moldable mass used to fill a given mold volume, higher porosity can be obtained.

As indicated by process block 22, the moldable porous mass can be distributed into a mold or otherwise spread into a desired shape. Plungers or spreaders can be utilized to distribute the mass to the desired height in the mold and achieve the desired porosity.

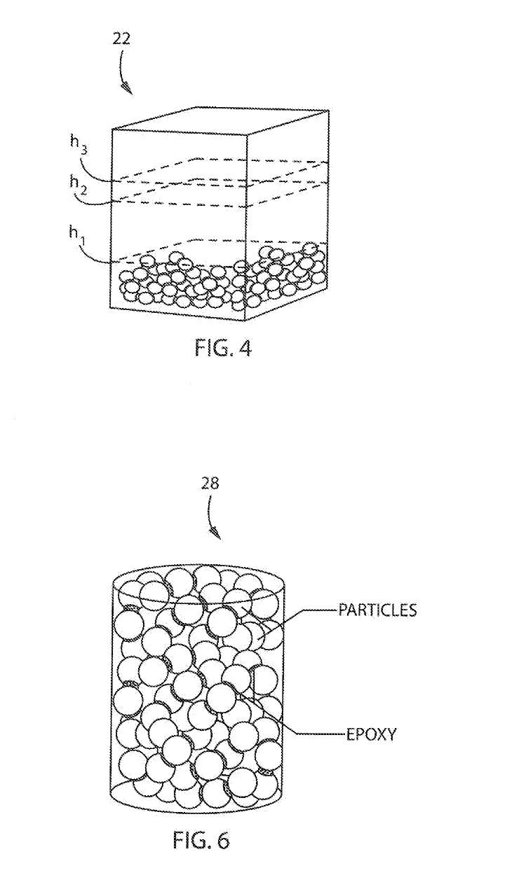

FIG. 4 schematically illustrates process block 20 and 22 whereby a predetermined weight of moldable porous mass is distributed into a mold at a predetermined height (h₁, h₂, h₃, etc.). The moldable porous mass is distributed at the predetermined height so that a desired volume of the mass is achieved. Referring again to FIG. 3, process blocks 12 through 22, and optionally blocks 24, 26, may be repeated a desired number of times in order to achieve a desired number of layers to create a multilayer structure of porous mass. This may be accomplished within the same mold. Process block 12 may be repeated with the same or different particle type. Process block 20 and 22 may be repeated with a different predetermined weight of moldable porous mass and a different predetermined height to be achieved so that the volume, porosity and thickness of the porous mass varies with each layer. It is also contemplated that the layers of the porous mass may he created separately and then adhered together after the mass has solidified. Typically, after hardening the solid porous mass is removed from the mold. To facilitate this, the mold could be fabricated from a material that does not readily adhere to the binding agent. For example, the mold could be made of Teflon™ or Delrin™, or from a metal (e.g. stainless steel) that has its surface coated with Teflon™. In addition, the surfaces of the mold in contact with the moldable porous mass may be coated with a mold-release agent prior to the introduction of the moldable porous mass. In this case, the mold-release agent should be pre-tested to ensure that it does not interact with the moldable porous mass and weaken the adhesion or bonding strength of the binding agent.

For some applications, for example for use in an AMR system, it is desirable to have the thermal regenerator apparatus inside an enclosure. In this case, the enclosure can also serve as the mold, and it is then desirable to maintain a strong bond between the moldable porous mass and the enclosure. To accomplish this, the surfaces of the mold in contact with the moldable porous mass may be coated with a thin layer of a binding agent, prior to the introduction of the moldable porous mass. The binding agent used for this is typically the same as the binding agent used in forming the moldable porous mass, although a different agent could be used as long as it does not adversely interact with the binding agent used in the moldable porous mass.

1.6. Spreading on Substrate and Hardening

As indicated by process block 24, in some cases, higher porosity structures can be obtained by introducing an additional step. In this step, clusters of two or more particles are first constructed. These clusters are then used to form the moldable porous mass, rather than the particles themselves. The clusters used to form the final moldable porous mass are irregular in shape (even though they may be made from smooth, regularly-shaped particles). When placed into a mold, the clusters tend to interlock, preventing the mass from settling into a lower porosity. Additionally, for the case where the clusters are formed from spherical particles, the surfaces within the porous flow paths are now smooth. The smooth rounded surfaces result in lower resistance to fluid flow than would be experienced by jagged irregular particles of a similar size.

The clusters can be fabricated by thinly spreading a moldable porous mass, formed using steps 1.1-1.4, onto a substrate, where it is then hardened into a rigid or semi-rigid sheet. As indicated by process block 26, upon removal from the substrate the rigid or semi-rigid sheet can be broken up into clusters. Then, additional binding agent is then added to the clusters to form a new moldable porous mass.

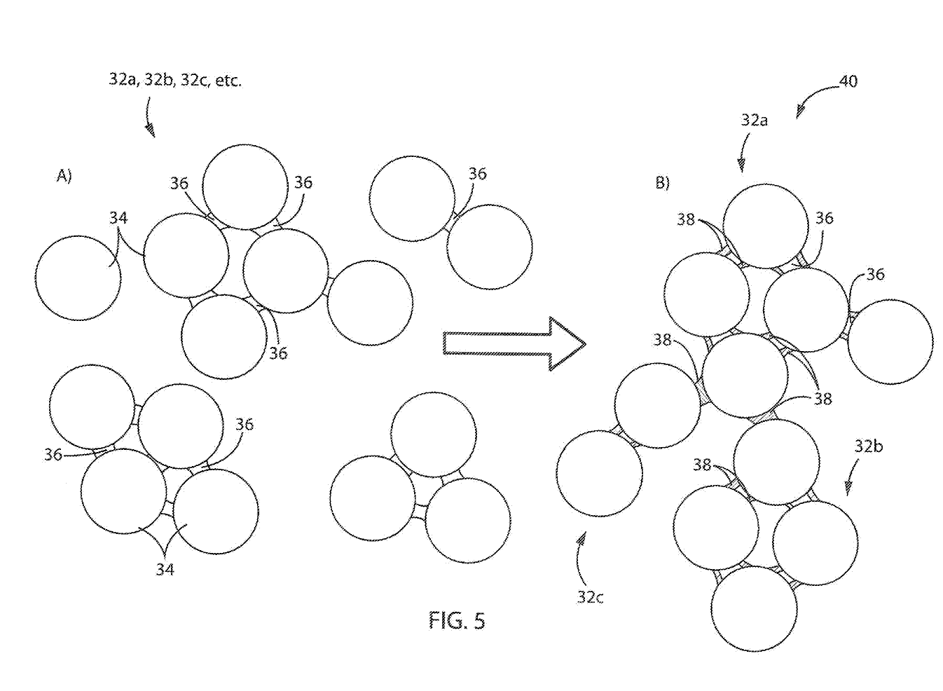

FIG. 5 illustrates schematically process block 26 whereby the rigid or semi-rigid sheet is broken up into clusters 32a, 32b, 32c, etc. As seen in (A), the clusters 32a, 32b, 32c, etc. of two or more spherical particles 34 are bound together by a primary binding agent 36. Then, as seen in (B), a secondary binding agent 38 is added to the clusters 32a, 32b, 32c, etc in order to form a final moldable porous mass 40 resulting from larger cluster assemblies. The particles are shown in FIG. 5 as partially separated in order to show the structure of the inter-particle binding agent necks, but, in practice, most of the particles may be in contact.

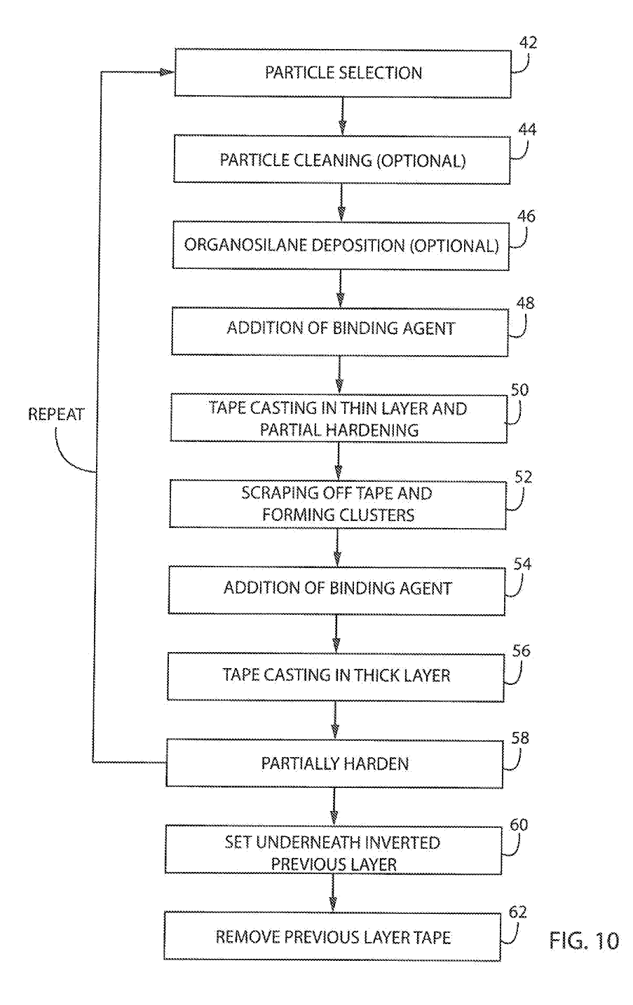

Referring to FIG. 10, in one embodiment of the present invention, a method of forming a multilayer structure of porous mass from pre-formed clusters is achieved by, using a tape casting process. As indicated by process blocks 42, a first particle is selected. As indicated by process blocks 44 and 46, optional particle cleaning and organosilane deposition steps may be performed before the addition of the binding agent to optimize adhesion. As indicated by process blocks 48, 50, a first binding agent is added to a first type of particles and then tape casted into a porous first thin layer of predetermined thickness, e.g., a thickness equal to two particle diameters. It is contemplated that other predetermined thicknesses may be used which accomplish the same goal. The first thin layer is then at least partially cured as it is carried on the tape through an oven. As indicated by process block 52, the clusters contained in the at least partially cured first thin layer are able to retain their configuration as the first cluster-containing mass is scraped off the tape. As indicated by process block 54, 56, a secondary binding agent is added to the first cluster-containing mass and then the mass is tape casted into a first thick layer corresponding to the desired layer thickness of the first type of particles in the final regenerator. As indicated by process block 58, the first thick layer is allowed to at least partially cure. The steps indicated by process blocks 42 through 58 are repeated with a second type of particle to create a second cluster-containing mass and a tape-casted second thick layer corresponding to the desired layer thickness of the second type of particles in the final regenerator. As indicated by process block 60, the first thick layer is inverted and placed on top of the exposed surface of the second thick layer. As indicated by process block 62, after the second thick layer has at least partially cured, the two layers are inverted and the tape substrate of the second layer is removed. Additional layers of additional types of particles of the desired thickness in the final regenerator can be added to the structure as required to form a layered porous structure. Layered porous regenerators of the desired final cross sectional area and shape can be cut or punched out of the layered porous structure and the last tape layer can be removed. The structure or the regenerators can be hardened as will be described below.

### 1. 7. Hardening of Binding Agent

Referring again to FIG. 3, as indicated by process block 28, after casting, the moldable mass can then be processed by standard room temperature curing, heat treatment, exposure to UV radiation, or other methods to harden the binding agent. The result is a rigid body that retains the original porosity present in the moldable porous mass, with particles strongly attached to one another funning a strong, porous three dimensional network that is sufficiently durable to withstand reciprocating fluid flow and cyclic magnetic forces.

Referring to FIG. 6, the schematic illustrates the rigid porous structure composed of spherical particles bonded together by following the method described above. Although the rigid porous structure is shown taking a cylindrical shape, the rigid porous structure may take any size and shape, such as a rectangular prism or an annular wedge.

### 1.8. Assembly of Final Structure

Referring again to FIG. 3, as indicated by process block 30, after the moldable mass has been hardened in the mold, the resulting structure can then be removed from the mold to produce a free-standing porous structure, which may be mounted in any desired enclosure for further use.

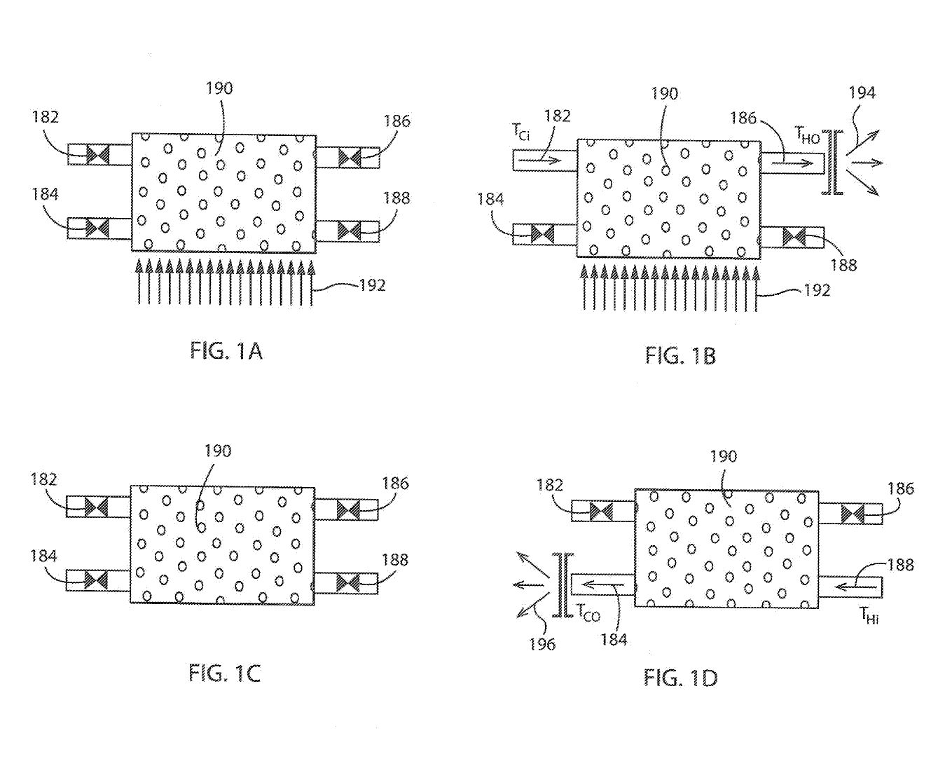

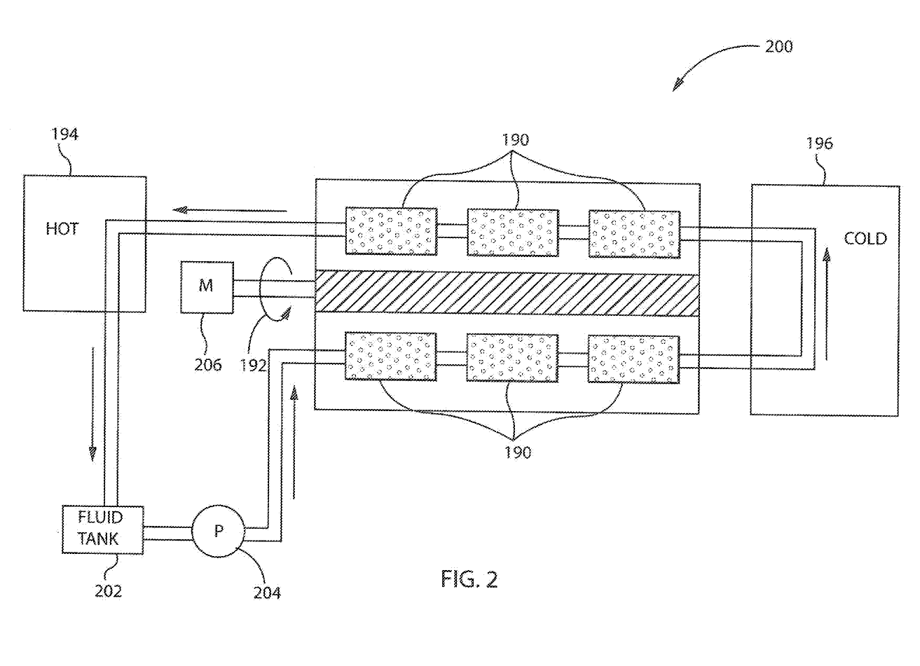

Referring again to FIGS. 1 and 2, in one embodiment, the enclosure containing the porous thermal refrigerator bed can be directly mounted in a magnetic refrigeration (MR) system employing an Active Magnetic Regenerator (AMR) cycle to perform cooling, as previously described.

Fluid flow through the apparatus may be in a variety of directions. For example, in a rectangular prism-shaped apparatus, flow may be conveyed between any two opposing end faces. In an annular wedge-shaped apparatus, flow may be conveyed in the radial direction (from the thinner portion of the wedge to the wider portion). In the angular direction, or in the axial direction.

### 2. Methods and Utility

The invention consists of several embodiments teaching a method. Each method involves a unique series (or combination) of the processing steps that are summarized above. Common to all methods is the formation of a moldable porous mass consisting of particles and a binding agent. This porous mass can be distributed or otherwise formed into any desired shape before hardening. For example, the apparatus may be rectangular, cylindrical, or in the shape of an annular wedge.

The rigid structure that results from application of these methods has a morphology that is well suited for application as porous thermal regenerator beds. Some characteristics of these structures that demonstrate the utility of this invention include:
Beds constructed by this method can have a porosity significant y higher than can be obtained in mechanically packed beds. In particular, porosities of 60 percent or higher are achievable.
Beds produced by this method exhibit frictional flow losses in agreement with the Ergun-MacDonald correlation, behavior that is consistent with a uniform pore size distribution, free from large scale voids and channels.
A properly selected and applied adhesion agent, e.g., an organosilane inter-layer, and appropriate choice of binding agent, e.g., an epoxy, can yield structures with strength that does not degrade appreciably in water.
The use of an adhesion agent, e.g., an organosilane inter-layer, with an appropriate choice of binding agent, e.g., epoxy, can produce beneficial dewetting of the binding agent from the particle surface, whereby it concentrates in the necks between particles. This improves heat transfer by avoiding insulating epoxy coatings on the particle surfaces.
The methods produce a structure that can adequately withstand reciprocating flow of an aqueous fluid and cyclic magnetic forces.

The methods outlined below involve selection of particles, particle surface preparation, pretreatment by organosilanes, applications of a binding agent (such as epoxy), casting, and hardening to produce rigid porous structures. Details of the methods are given, with examples specifically for the case of spherical particles of iron-based, strongly magnetic metallic alloys (e.g., La(Fe₁₋ₓSiₓ)₁₃H_{y}). It is understood that these methods can be readily applied to other materials and particle shapes. For example, the methods can be applied to non-spherical regular shapes such as ellipsoids, or to irregular shapes, such as particles formed by crushing, media milling, jet milling or grinding processes. The methods can be applied to other magnetic or magnetocaloric materials, such as Fe, Gd or its alloys made from Gd, La(Fe,Si)₁₃H_{y}, La((Fe,Mn),Si)₁₃H_{y}, La((Fe,Co),Si)₁₃, (Mn,Fe)(P,As), (Mn,Fe)(P,Si), and (Mn,Fe)(P,Ge), or to non-magnetic materials, such as copper, lead, or stainless steel.

Using these methods, a moldable porous mass is produced, which can then be cast into various simple or complex shapes. This moldable mass is characterized by loose particles that may be fully or partially coated by a binding agent. The binding agent typically collects in the vicinity of the contact points between particles, forming necks. The moldable mass also retains an open, porous structure in which voids, free from binding agent, remain between particles. Upon hardening of the binding agent (by heat curing, for example), a rigid porous structure (body) is formed. This body has a number of important characteristics that can include:
A three dimensional network of particles that are strongly bonded to one another, with bonds that are sufficiently strong to withstand the forces due to rapidly changing magnetic fields as well as the reciprocating flow of the aqueous heat transfer fluid.
A controlled porosity that can readily exceed 40 percent for spherical particles, and in some cases with spheres, can exceed 60 percent.
In the case of irregular particles, porous thermal regenerators wherein the ratio of the average porosity of the porous bed to the tapped porosity of the unbound irregular particles comprising the porous bed is at least 1.05. “Tapped porosity” refers to a random close packing obtained by placing irregular particles into a container and shaking or tapping the container until the objects do not compact any further. For spheres, random close packing provides a particle volume fraction of 0.64. The “tapped porosity” of unbound particles is determined by dissolving the epoxy from the structure, cleaning and drying the structure, then shaking or tapping the container to cause the unbound particles to settle under the influence of gravity, then measuring the porosity.
Porosity that is uniformly distributed throughout the structure, free from large scale voids and channels.
Multiple internal layers.
A simple or complex shape of the resulting porous thermal regenerator bed.

### 2.1. Method I

This method involves the addition of a binding agent to rigorously cleaned particles, forming a moldable porous mass. The mass is then cast into a desired shape, followed by hardening of the binding agent to produce a rigid structure with controllable porosity that is strong and durable.

### 2.1.1. Particle Selection

Particles are typically selected to have a desired uniform shape and a narrow size range, with a surface that is largely free from corrosion. Examples of materials that have been successfully cleaned and formed into epoxy-connected structures using this method include La(Fe₁₋ₓSiₓ)₁₃, La(Fe₁₋ₓSiₓ)₁₃H_{y}, carbon steel, 316L stainless steel, and copper. Some particle sizes that have been successfully used with this method include 53-75 μm, 75-90 μm, 165-212 μm, 212-246 μm, and 178-246 μm diameters. The desired particle size range can be obtained by sieving of the particles between successive standard sieve sizes.

### 2.1.2. Surface Cleaning

The particle surfaces are then rigorously cleaned via ultrasonic agitation in a series of detergents and solvents, for example Alconox™, acetone, methanol, and isopropanol. Agitation for several minutes in each solution is followed by rinsing on filter paper, after which the particles are transferred into the next solution, or dried. For example, LaFeSi particles have been successfully cleaned using ultrasonic agitation in Alconox™, followed by ultrasonic agitation in acetone, followed by ultrasonic agitation in isopropanol, then dried in air for 15 minutes at 50 C.

### 2.1.3. Addition of Binding Agent

A binding agent is added to the particles, then mixed to form a moldable porous mass. It is generally advantageous to use the minimum amount of binding agent that achieves the desired strength in the finished structure. For epoxies used as the binding agent (e.g., Hysol™ 9430, ResinLabs™ EP691, or Stycast™ 1266), the typical ratio of epoxy mass to particle mass is in the range of 1%-3.5%. Typically, a series of test structures are fabricated with different values of this ratio and their strength is evaluated. The smallest ratio that resulted in an acceptable strength is then used for further fabrication. These tests may be repeated with different binding agents to identify the best binding agent for a given application.

The mixing technique typically involves stirring the particles until the binding agent is fully distributed throughout the volume of particles, and a moldable porous mass of uniform consistency is achieved. The mixing technique should result in a moldable porous mass with a porosity that is larger than the desired porosity after casting. To maintain the ratio of epoxy mass to particle mass, the mixing should be performed with an implement that does not readily adhere to or wick up the binding agent. Successful results have been obtained, for example, with a thin wooden stick.

2.1.4. Measurement of the Moldable Porous Mass

Porosity of the final structure is controlled by precise measurement of the quantity of the moldable porous mass that is added to the mold. The moldable porous mass consists of particles and binding agent mixed in a specific and predetermined volume or mass ratio. For example, for epoxies used as binding agents, the typical ratio of epoxy mass to particle mass is in the range of 1%-3.5%. These ratios, along with the volume of the mold (or portion of the mold) to be filled, are used to calculate the precise amount (mass) of the moldable porous mass needed to achieve the desired porosity after casting. To illustrate this calculation, let V_{mold} represent the desired mold volume to be filled, let M represent the mass of the moldable porous mass, let ρₑ, Vₑ, and Mₑ represent the density, volume, and mass of the binding agent in the moldable porous mass to be used to fill V_{mold}, and let ρₚ, Vₚ, and Mₚ represent the density, volume, and mass of the particles in the moldable porous mass. We define the binding agent:particle volume ratio to be r_{V}=Vₑ/Vₚ and the binding agent:particle mass ratio to be r_{M}=Mₑ/Mₚ. We note that these ratios are chosen before the porous moldable mass is made, usually after strength testing has been conducted. Further, we note that r_{V} and r_{M} are related in the following fashion:

(1)

$${r}_{V} = \frac{{ρ}_{p}}{{ρ}_{e}} {r}_{M}$$

Therefore, the two ratios are not independent: knowledge of one ratio determines the value of the other ratio.

Finally, let φ represent the desired porosity of the structure. By definition,

(2)

$$φ = \frac{{V}_{mold} - {V}_{p} - {V}_{e}}{{V}_{mold}} = 1 - {V}_{p} \frac{1 + {V}_{e} / {V}_{p}}{{V}_{mold}} = 1 - {V}_{p} \frac{1 + {r}_{V}}{{V}_{mold}}$$

We note that Vₚ=Mₚ/ρₚ and M=Mₒ+Mₑ=Mₚ(1+r_{M}), so that Mₚ=M/(1+r_{M}) and therefore

(3)

$${V}_{p} = \frac{M}{{ρ}_{p}} \frac{1}{1 + {r}_{M}}$$

We now substitute (3) into (2) and solve for M. We find that

(4)

$$M = ( 1 - φ ) {ρ}_{p} {V}_{mold} \frac{1 + {r}_{M}}{1 + {r}_{V}}$$

Thus, to obtain the desired porosity φ to be made from a moldable porous mass with volume and mass ratios r_{V} and r_{M}, we use mass M given by (4).

### 2.1.5. Casting

Referring to FIG. 4, the moldable porous mass can be distributed into a mold or otherwise spread into a desired shape. For example, the mass can be spread into a mold, completely filling the cross section such that the mass achieves the desired height inside the mold. A thin tool (such as a steel needle) may be used to push material into mold corners to ensure that the cross section is filled. Plungers or spreaders can be utilized to distribute the mass to the desired height and thereby fill the desired mold volume. This will ensure that the desired porosity is obtained.

Casting can involve a single layer, or may involve several layers in turn, so as to build a multilayer structure. To facilitate this, the mold itself can be constructed from multiple layers. These layers may have different thicknesses. In addition, it may be desirable for the layers to have different porosities. This can be accomplished by altering the amount (mass) of the moldable porous mass placed in different layers, in accordance with section 2.1.4.

For certain, applications, it may be desirable for the moldable porous mass in the mold to have a very smooth and flat exposed surface. This would be desirable, for example, in the formation of multilayered structures, where the boundary between layers needs to be smooth and distinct. To accomplish this, a “screeding” process can be used. This type of process is used in the formation of smooth surfaces on molded concrete structures, such as sidewalks. In this process, the mold is filled with all or a portion of the moldable porous mass. A flat tool that does not readily adhere to the binding agent (e.g., a flat glass, plastic, or wooden rectangle) is supported on the edges of the mold. While providing pressure to keep it flat and in contact with the edges of the mold, the tool is moved rapidly back and forth and slid slowly along the edges of the mold, leaving a smooth surface on the moldable porous mass in its wake. If any depressed regions are observed in the surface, small amounts of the moldable porous mass are added to the mold and the screeding process is repeated until all of the desired moldable porous mass has been used and a smooth surface has been obtained. In forming a multilayer structure, the screeding process is performed after each layer is cast.

Typically, after hardening the solid porous mass is removed from the mold. To facilitate this, the mold should be fabricated from a material that does not readily adhere to the binding agent. For example, the mold could be made of Teflon™ or Delrin™. Alternatively, the mold could be made from a metal (e.g., aluminum or stainless steel) that has been coated with Teflon™. Alternatively, or in addition, the surfaces of the mold in contact with the moldable porous mass may be coated with a mold-release agent prior to the introduction of the moldable porous mass. In this case, the mold-release agent should be pre-tested to ensure that it does not interact with the moldable porous mass and weaken the adhesion or bonding strength of the binding agent. Another means to facilitate removal of the solid porous mass from the mold after hardening is to construct the mold from several parts which, when assembled together form a chamber comprising the mold volume, but the parts can be separated after hardening of the moldable porous mass.

For some applications, for example for use in an AMR system, it is desirable to have the thermal regenerator apparatus inside an enclosure. In this case, the enclosure can also serve as the mold, and it is then desirable to maintain a strong bond between the moldable porous mass and the enclosure. To accomplish this, the surfaces of the mold in contact with the moldable porous mass may be coated with a thin layer of a binding agent, prior to the introduction of the moldable porous mass. The binding agent used for this is typically the same as the binding agent used in forming the moldable porous mass, although a different agent could be used as long as it does not adversely interact with the binding agent used in the moldable porous mass.

### 2.1.6. Hardening of Binding Agent

After casting, the moldable mass can then be processed by heat treatment or other methods to harden the binding agent and produce a rigid porous structure. For example, a commercially available epoxy can be cured in air at 50 C for several hours to produce a rigid structure that retains its as-cast porosity. In the case of a single layer bed, the hardening may be performed immediately after casting. In the case of multilayer beds, the hardening step may be performed after each layer is cast, or only after all the layers have been cast.

### 2.1.7. Assembly of Final Structure

After hardening, the thermal regenerator apparatus that consists of one or more layers is typically ready for use. Usually, after being hardened in the mold, the resulting structure can then be removed from the mold to produce a free-standing porous structure, which may be mounted in any desired enclosure for further use. As noted in 2.1.5, for use in an AMR system, it is desirable to cast the bed and harden the binding agent in an enclosure (such as a shell) which also serves as the mold. The enclosure containing the bed can then be directly mounted in the AMR system.

2.18 Disassembly of Final Structure

If it is desired to disassemble a thermal regenerator apparatus in order to recover the magnetocaloric material for use in a new device, the epoxy in the porous structure could be dissolved and removed with a epoxy-removal solvent, such as the methylene chloride based solvent “Attack”, manufactured by B. Jadow and Sons, or the solvent Dynasolve 185, manufactured by Dynaloy, LLC. This dissolution procedure, followed by packing the particles in a container, tapping the container, and then measuring the porosity, would also allow determination of the tapped porosity achievable with the particles that were originally contained in the bed.

### 2.2. Method II

This method involves the addition of a binding agent to particles that were rigorously cleaned and coated with an organosilane, forming a moldable porous mass. The mass is then cast into a desired shape, followed by hardening of the binding agent to produce a rigid structure with controllable porosity that is strong and durable.

2.2.1. Particle Selection

Particles are selected in the same manner as described in section 2.1.1.

### 2.2.2. Surface Cleaning

Particles are cleaned in the same manner as described in section 2.1.2. In some cases, it may be desirable to immerse the particles directly into the organosilane solution after cleaning, without an intermediate drying step. To prevent water contamination of the organosilane solution, the particles should not be transferred into the solution if they are taken directly from cleaning in isopropanol, which can have water contamination. It is therefore recommended that methanol, rather than isopropanol, be used for the last cleaning step. If the particles have been dried after the last cleaning step, it may be desirable to rinse them with methanol prior to their immersion in the organosilane solution to remove any possible water contamination.

### 2.2.3. Organosilane Deposition

An adhesion promoter is a bi-functional compound that can chemically react with both the substrate and the adhesive. An adhesion promoter's effectiveness depends on both the substrate and the adhesive being used. The most common adhesion promoter is based on silane coupling agents.

Organosilanes are widely used as adhesion promoters and their preparation and application use techniques that are well known to those skilled in the art. Their use in the present invention results in rigid, porous structures with greater strength when exposed to aqueous fluid. The key activity of these organosilanes includes the formation of a covalent bond with the (previously hydrolyzed) particle surface, and with a free amine group. When used with an epoxy as the binding agent, this free amine group can participate in the later epoxy crosslinking, resulting in strong adhesion between the particle and the epoxy.

After cleaning, particles are placed into an organosilane solution. As described in section 2.2.2, it may be desirable to rinse the particles with methanol before immersion in the organosilane solution. This solution is typically prepared using accurately measured amounts of solvent, organosilane, and acids to produce a fully hydrolyzed solution with tight pH control. For example, it has been found experimentally that with several commercial epoxies (Hysol™ 9430, ResinLabs™ EP691, Stycast™ 1266), successful results are obtained using acetic acid to produce a pH in the range of 9.3-9.6.

Organosilane film thickness is controlled by the time the particles remain immersed, with best results found in the thickness range of 100-300 nm. The immersion time needed to achieve this film thickness is approximately two minutes, while being stirred. After deposition, the excess solution is decanted, and the particles are cured in an air oven at temperatures below 80 C.

Some organosilanes that have been successfully applied in various combinations of the materials listed in section 2.1.1 include

1) Bis[3-(trimethoxysilyl)propyl]-amine (CAS 82985-35-1), also referred to as BTS-PA,

2) Bis[3-(triethoxysilyl)propyl]-tetrasulfide (CAS 40372-72-3),

3) (3-Aminopropyl)triethoxysilane (CAS 919-30-2),

4) 1,2-Bis(triethoxysilyl)ethane (CAS 16068-37-4).

### 2.2.4. Addition of Binding Agent

The binding agent is added in the same manner as described in section 2.1.3.

### 2.2.5. Measurement of the Moldable Porous Mass

A predetermined amount (mass) of the moldable porous mass is selected as described in section 2.1.4 to obtain the desired porosity.

### 2.2.6. Casting

The moldable porous mass is cast in the same manner as described in section 2.1.5 and as seen in FIG. 4.

2.7.7. Hardening of Binding Agent

A rigid three dimensional structure is produced by hardening of the binding agent as described in section 2.1.6 and as seen in FIG. 6.

### 2.2.8. Assembly of Final Structure

The final structure is assembled as described in section 2.1.7.

### 2.3. Method III

This method involves the addition of a primary binding agent to rigorously cleaned particles, forming a moldable porous mass. The mass is then spread as a thin layer onto a substrate, followed by partial hardening of the binding agent to produce a rigid or semi-rigid bonded array of particles. This array is then removed from the substrate and broken up so as to form small clusters consisting of 2 or more particles, along with some individual particles. A secondary binding agent is then added to the clusters and mixed to form a moldable porous mass with high porosity. The mass is then cast into a desired shape, followed by hardening of the binding agent to produce a rigid structure with controllable porosity that is strong and durable.

This method offers an important advantage over Methods I and II. The clusters used to form the final moldable porous mass are irregular in shape (even though they may be made from smooth, regularly-shaped particles). When placed into a mold, the clusters tend to interlock, preventing the mass from settling into a lower porosity. Additionally, for the case where the clusters are formed from spherical particles, the surfaces within the porous flow paths are now smooth. The smooth rounded surfaces result in lower resistance to fluid flow than would be experienced by jagged irregular particles of a similar size.

### 2.3.1. Particle Selection

Particles are selected in the same manner as described in section 2.1.1.

### 2.3.2. Surface Cleaning

Particles are cleaned in the same manner as described in section 2.1.2.

### 2.3.3. Addition of Primary Binding Agent

A primary binding agent is added to the particles, then mixed to form a moldable porous mass. Typically, this step uses smaller binding agent:particle mass and volume ratios than steps 2.1.3 or 2.2.4. In general, the amount of the primary binding agent to use is determined experimentally. The purpose of the primary binding agent is to form highly porous multi-particle clusters of particles. If too much binding agent is used, the excess fills the spaces between particles in a cluster, resulting in low porosity. If too little binding agent is used, no clusters are formed: after removal from the substrate, the thin bonded array of particles breaks up into individual particles. The amount of the primary binding agent should be as small as possible while still resulting in porous, multi-particle clusters. For example, one typically begins this experimental process by choosing the total binding agent:particle mass ratio that is desired for the finished structure. This is typically 1.75% when the binding agent is a commercial epoxy (e.g., Hysol™ 9430, ResinLabs™ EP691, or Stycast™ 1266). Following section 2.1.4, we will refer to this volume ratio as r_{M}. A fraction, denoted by “f”, of this ratio is used for the primary binding agent, and a fraction denoted “1−f” is used for the secondary binding agent. Given a particle mass Mₚ, then a mass of primary binding agent of f×r_{M}×Mₚ is used. Test structures are made using various values of f until a value is found that achieves the desired results. For example, with typical commercial epoxies (e.g., Hysol™ 9430, ResinLabs™ EP691, or Stycast™ 1266) and with r_{M}=1.75%, good results were obtained with f=0.2 when forming multi-particle clusters from LaFeSi spheres 165-212 μm in diameter. We note that the primary binding agent:particle mass ratio is given by f×r_{M}, which is equal to 0.35% in this example.

### 2.3.4. Spreading on Substrate and Hardening

The moldable porous mass is spread as a thin layer on a substrate. The binding agent is then partially hardened to produce a thin, semi-rigid bonded array of particles. Alternatively, the moldable porous mass may be spread, as a thin layer on one substrate. A second substrate can then be compressed over this layer. The two substrates can then be moved relative to each other while being compressed to form a uniform thin layer of the multiple porous mass that will have an approximate thickness of one particle diameter. The substrates can then be separated, forming two properly-coated substrates. The binding agent can then be partially hardened to produce thin, semi-rigid bonded arrays of particles on each substrate.

The substrate should be fabricated from a hard material that does not readily adhere to the binding agent. For example, the substrate could be made from Teflon™, Delrin™, or high-density polyethylene (HDPE). After partial hardening of the binding agent, the semi-rigid sheet can be scraped off the substrate using, for example, a razor blade, and broken into small clusters. Sonic individual particles may be present along with the clusters. If desired, sieving can be used to select clusters having a particular size distribution.

The hardening time for the layer on the substrate is a critical parameter. The binding agent must be partially, but not completely, hardened. The hardening time should be chosen so that the layer, when scraped off the substrate, forms multi-particle clusters of particles that are tacky and will still adhere to each other. If the binding agent is insufficiently hardened, clusters will not form—the material when scraped off will form a connected mass. If the binding agent is too hard, the clusters will be composed of small numbers of particles or single particles that do not adhere to each other. In general, the proper hardening time must be found experimentally. For example, with ResinLabs™ EP691 epoxy and LaFeSi spheres 165-212 μm in diameter with epoxy:particle mass ratio of 0.35% (r_{M}=1.75%, f=20%) spread onto clean sheets of rigid HDPE or glass, the proper hardening time is 14 hours at room temperature.

### 2.3.5. Addition of Secondary Binding Agent

Referring again to FIG. 5, a binding agent is added to the mass of clusters, then mixed to form a moldable porous mass. The amount of binding agent is precisely controlled to ensure that the structure has desired strength, but voids between particles remain. Typically, this step uses smaller binding agent:particle mass and volume ratios than steps 2.1.3 or 2.2.4. As for the primary binding agent, the amount of secondary binding agent is found experimentally by varying the fraction f defined in section 2.3.3. With typical commercial epoxies (e.g., Hysol™ 9430, ResinLabs™ EP691, or Stycast™ 1266) and with r_{M}=1.75%, good results were obtained with f=0.2 when forming multi-particle clusters from LaFeSi spheres 165-212 μm in diameter. As described in step 2.3.3, a fraction of 1−f=0.8 was then used for the secondary binding agent. That is, the mass of secondary epoxy used was 0.8×r_{M}×Mₚ, giving a secondary epoxy:particle mass ratio of 1.4%. With these choices for r_{M} and f, robust structures with a porosity greater than 60 percent were obtained.

The secondary binding agent and clusters are added together and thoroughly but gently mixed. The goal is to evenly distribute the secondary binding agent without breaking up the clusters. Typically, a thin wooden stick is used for the mixing. In general, the mixing tool should be made from material which does not readily adhere to the secondary binding agent or wick it up.

The secondary binding agent may be different from the primary binding agent. For example, the primary binding agent may be ResinLabs™ EP691 while the secondary binding agent may be Stycast™ 1266. Experimental verification of the adhesion of the secondary binding agent to the primary binding agent should be performed, as not all secondary binding agents will adhere to the partially hardened primary binding agent. For example, Hysol™ 9430, when used as a secondary binding agent, did not adhere to partially hardened Hysol™ 9430 used as the primary binding agent.

### 2.3.6. Measurement of Moldable Porous Mass

A predetermined amount (mass) of the moldable porous mass is selected as described in section 2.1.4, with r_{V} and r_{M} representing the total (i.e., the total amount of primary and secondary binding agents) binding agent:particle volume and mass ratios.

### 2.3.7 Casting

The moldable porous mass is cast in the same manner as described in section 2.1.5 and as seen in FIG. 4.

2.3.8. Hardening of Binding Agent

A rigid three dimensional structure is produced by hardening of the binding agent as described in section 2.1.6 and as seen in FIG. 6.

### 2.3.9. Assembly of Final Structure

The final structure is assembled as described in section 2.1.7.

### 2.4. Method IV

This method involves the addition of a binding agent to particles that were rigorously cleaned and coated with an organosilane, forming a moldable porous mass. The mass is then spread as a thin layer onto a substrate, followed by hardening of the binding agent to produce a rigid or semi-rigid bonded array of particles. This array is then removed from the substrate and broken up so as to form small clusters consisting of two or more particles, along with some individual particles. A binding agent is then added to the clusters and mixed to form a moldable porous mass with high porosity. The mass is then cast into a desired shape, followed by hardening of the binding agent to produce a rigid structure with controllable porosity that is strong and durable, even under exposure to aqueous fluids.

### 2.4.1. Particle Selection

Particles are selected in the same manner as described in section 2.1.1.

### 2.4.2. Surface Cleaning

Particles are cleaned in the same manner as described in section 2.1.2.

### 2.4.3. Organosilane Deposition

An organosilane coating is deposited on the particles in the same manner as described in section 2.2.3.

### 2.4.4. Addition of Primary Binding Agent

A binding agent is added to the particles in the same manner as described in section 2.3.3.

### 2.4.5. Spreading on Substrate and Hardening

The moldable porous mass is processed in the same manner as described in section 2.3.4.

### 2.4.6. Addition of Secondary Binding Agent

A secondary binding agent is added to the mass of particles and clusters in the same manner as described in section 2.3.5.

### 2.4.7. Measurement of the Moldable Porous Mass

A predetermined amount (mass) of the moldable porous mass is selected as described in section 2.1.4.

### 2.4.8. Casting

The moldable porous mass is cast in the same manner as described in section 2.1.5 and as seen in FIG. 4.

### 2.4.9. Hardening of Binding Agent

A rigid three dimensional structure is produced by hardening of the binding agent as described in section 2.1.6 and as seen in FIG. 6.

### Assembly of Final Structure

The final structure is assembled as described in section 2.1.7.

### EXAMPLES

### Example 1

### Strength Improvement with Methods I and II

Method I was used to fabricate a number of rigid porous structures from spherical particles of LaFeSi. Each structure had a rectangular cross-section with each dimension measuring at least 10 mm. Here, we provide further details of fabrication process:
1. The particles were sieved using standard sieves to have diameters between 165 and 212 microns.
2. The particles were cleaned by ultrasonic agitation for 4 minutes in Alconox. The Alconox was decanted and the wet particles were rinsed with distilled water and transferred to a beaker for ultrasonic agitation in acetone for 2 minutes. The acetone was decanted and the particles were rinsed in isopropanol. They then were subjected to ultrasonic agitation in isopropanol for 2 minutes, after which the particles were placed on filter paper and dried at 50 C for 15 minutes.
3. Structures were made with two binding agents, ResinLabs™ EP691 and Hysol™ 9430. The epoxy:particle mass ratio for both binding agents was 1.75%. The moldable porous mass was formed in a plastic beaker using a wooden stick for mixing. The mass was then transferred to a Delrin™ mold. The amount (mass) of the moldable porous mass was varied according to formula (4) to obtain structures with different porosities ranging from 36% to 48%. The open surface of the mold was then screeded.
4. The molds were then allowed to cure at room temperature for at least 14 hours. The moldable porous mass, now solidified, was removed from the mold. The free-standing structures were then placed in an oven 50 C for at least 2 hours, at which point the structures had cured completely.

Method II was used to fabricate a number of rigid porous structures from spherical particles of LaFeSi. Each structure had a rectangular cross-section with each dimension measuring at least 10 mm. Here, we provide farther details of the fabrication process:
1. The particles were sieved using standard sieves to have diameters between 165 and 212 microns.
2. An organosilane solution was formed from 48 cc of methanol and 2 cc of BTS-PA. The pH of the solution was adjusted by the addition of acetic acid to be between 9.3 and 9.6. The solution was then magnetically stirred at room temperature for 1 hour.
3. The particles were cleaned by ultrasonic agitation for 4 minutes in Alconox. The Alconox was decanted and the wet particles were then rinsed with distilled water, and transferred to a beaker for ultrasonic agitation in acetone for 2 minutes. The acetone was decanted and the particles were rinsed in methanol. They then were subjected to ultrasonic agitation in methanol for 2 minutes. The methanol was decanted and the particles were added to the organosilane solution.
4. The particles were stirred in the organosilane using a bamboo skewer for 1 minute 40 seconds. The solution was decanted and the particles were transferred to filter paper and cured in an oven at 50 C for 1 hour.
5. ResinLabs™ EP691 was used as the binding agent. The epoxy:particle mass ratio was 1.75%. The moldable porous mass was formed in a plastic beaker using a wooden stick for mixing. The mass was then transferred to a Delrin™ mold. The amount (mass) of the moldable, porous mass was varied according to formula (4) to obtain structures with different porosities ranging from 36% to 44%. The open surface of the mold was then screeded.
6. The molds were then allowed to cure at room temperature for at least 14 hours. The moldable porous mass, now solidified, was removed from the mold. The free-standing structures were then placed in an oven at 50 C for at least 2 hours, at which point the structures were completely cured.

The rigid porous structures (beds) made above are intended to withstand the cyclic stresses associated with magnetic field cycling and reciprocating fluid flow found in AMR systems. After fabrication, the adhesive and cohesive strength of these beds were evaluated to determine if they could withstand the stresses associated with AMR system operation over long time periods.

Several new testing methods were developed to assess the strength of these connections. In one test, a hardened steel needle was scratched under constant load across the faces of test beds prepared under different conditions. Microscopic examination of the scratched regions indicated that individual (whole) particles were dislodged by the needle, leaving behind necks that remained intact and connected to other particles in the bed. This test, therefore, probes the interfacial bond strength, with the number of particles removed being inversely proportional to the bond strength. A “hardness” parameter H_{b} was defined to be the reciprocal of mass removed per unit length of scratch, with units [cm/g], as a function of the porosity of the beds made with Methods I and II described above.

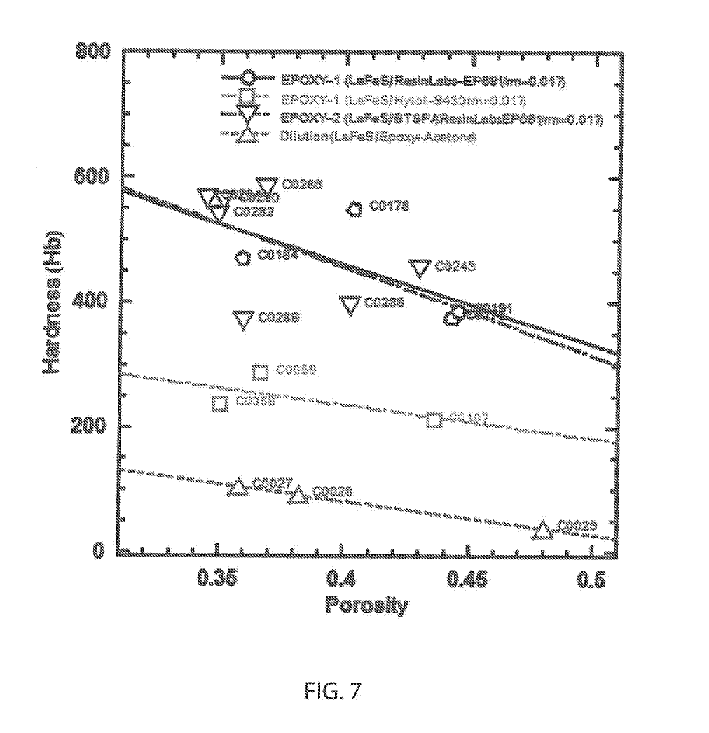

Referring to FIG. 7, the scratch hardness data is shown for connected beds of LaFeSi spheres prepared by various techniques. Beds produced by Methods I and II (using ResinLabs™ EP691 epoxy) exhibited the greatest resistance to scratch erosion. Beds produced by Method I (using Hysol™ 9430), and the epoxy-dilution process were significantly weaker.

Beds prepared with Method I, plotted as circles in FIG. 7, exhibited hardness between 400 and 600 [cm/g]. It is evident that the hardness typically decreases slightly with porosity. Beds prepared by the Method II and the same epoxy were of equivalent strength. A different epoxy (Hysol™ 9430) produced weaker beds, hardness between 200 and 300 [cm/g]. The conventional epoxy-dilution process produced beds that were dramatically weaker, hardness between 25 and 100 [cm/g].

Additional experiments of similarly prepared beds cycled in a 1.44 Tesla magnetic field indicated that beds with a scratch hardness (H_{b}) below 200 [cm/g] will rapidly disintegrate after a few thousand cycles, while those with a higher hardness survive. Therefore, we concluded that beds made using Methods I and II had sufficient strength to survive under AMR conditions, while beds made with the conventional process did not.

Organosilane pretreatment is generally believed to provide resistance to weakening under contact with water. To verify this, a second test based on tumbling of epoxy-connected structures in an aqueous environment was developed. In this test, epoxy-connected LaFeSi structures (beds) were cast in the form of identical balls 6.34 mm in diameter, using both Methods I and II. In the latter case, particles were coated with the organosilane Bis[3-(trimethoxysilyl)propyl]-amine (BTS-PA) before application of the epoxy. The molds used for casting consisted of two hemispherical shells; the moldable porous mass was compressed inside these shells. After curing and removal from the molds, beds were soaked in distilled water for various times (0 to 336 hours), then tumbled in distilled water along with ceramic tumbling media. Over the course of several hours, the beds were found to be gradually reduced in size by erosion. They were periodically removed from the tumbler, weighed to determine the total amount of mass lost, and returned to the tumbler for further testing. From these experiments, it has been found that most beds eroded at a constant rate [in units of kg/m²·sec]. This erosion rate was found to be strongly dependent on the preparation method, and was inversely proportional to the overall bed strength H_{b}. A hardness parameter Hₑ₀, corresponding to the inverse of the erosion rate, was defined to characterize strength under the test conditions.

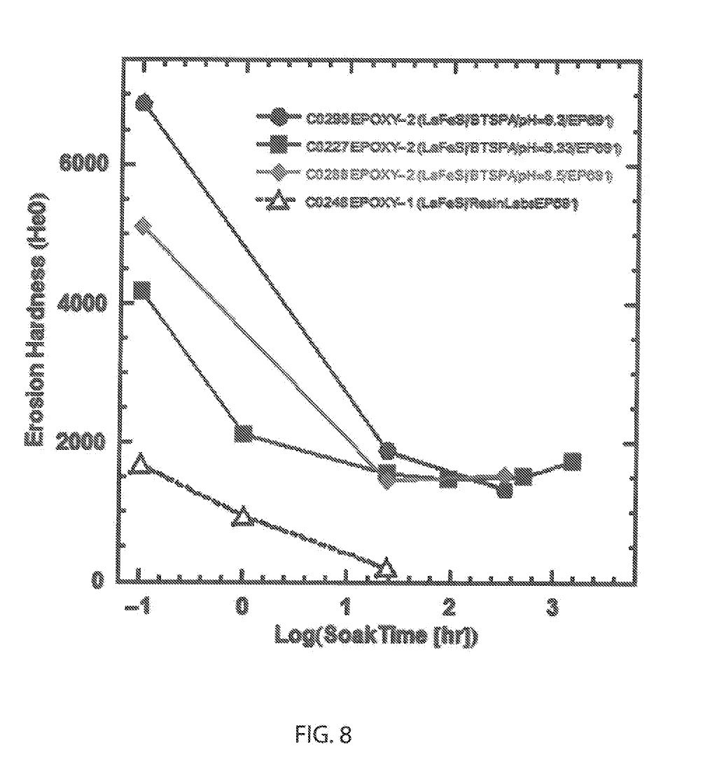

Referring to FIG. 8, hardness parameter Hₑ₀ [m²·sec/kg] is shown for several example beds produced by different epoxy connection methods. Each data point corresponds to an individual bed that was presoaked in distilled water, then tumbled in a slurry of distilled water and ceramic media.

Beds prepared without an organosilane coating (Method I) were significantly weaker than those prepared with the organosilane BTS-PA coating (Method II). The Method I beds typically became weaker as they soaked in distilled water, with Hₑ₀ decreasing with the soak time. In contrast, the organosilane coated (Method II) beds showed an initial drop in strength after 24 hours of water exposure, but then retained their strength even after 1000 hours of exposure.

### Example 2

### Increased Porosity with Method III

Dry spherical particles with narrow size range typically pack with a natural porosity in the range 0.34 to 0.40. However, for use in practical AMR systems, beds with a porosity significantly higher than 0.40 are needed to reduce flow losses during operation. Methods III and IV described above can produce beds with porosity of 0.50 or greater. It is also important to confirm that the higher porosity is evenly distributed throughout the bed, and that the beds are free from large-scale voids or channels that would allow flow to bypass regions of the bed and reduce overall heat transfer. To confirm the uniformity of the porosity, Method III was used to make a number of rigid structures with rectangular cross sections measuring 24 mm×15 mm×7 mm from spherical particles of LaFeSi. Here, we provide further details of the fabrication process:
1. The particles were sieved using standard sieves to have diameters between 165 and 212 microns.
2. The particles were cleaned by ultrasonic agitation for 4 minutes in Alconox. The Alconox was decanted and the wet particles were rinsed with distilled water and transferred to a beaker for ultrasonic agitation in acetone for 2 minutes. The acetone was decanted and the particles were rinsed in isopropanol. They then were subjected to ultrasonic agitation in isopropanol for 2 minutes, after which the particles were placed on filter paper and dried at 50 C for 15 minutes.
3. ResinLabs™ EP691 was used as the primary binding agent. The total mass ratio was r_{M}=1.75%. The primary binding agent fraction was f=20%. The primary epoxy was mixed with the particles in a plastic beaker using a wooden stick. The mixture was pressed between two glass plates and the plates were compressed and moved relative to each other to obtain a thin layer approximately one particle diameter in thickness. Then the plates were pulled apart and left to partially cure at room temperature. After approximately 14 hours, the material was scraped off the plates. At this point, the material broke up into distinct multi-particle clusters; the clusters were tacky and would bond to each other if allowed to sit undisturbed.
4. Stycast™ 1266 was used as the secondary binding agent. The secondary binding agent fraction was 1−f=80%. The epoxy was mixed with the tacky clusters in a plastic beaker using a wooden stick. The mixing was performed in a gentle manner to avoid breaking the clusters.
5. The moldable porous mass was transferred to a Delrin™ mold. The mass of this mixture was chosen to produce a porosity of 50%. The molds were then allowed to cure at room temperature for at least 14 hours. The moldable porous mass, now solidified, was removed from the mold. The free-standing structures were then placed in an oven at 50 C for at least 2 hours, at which point the structures had completely cured.

The fully cured free-standing structures made above were then mounted in a fixture that allowed fluid flow to be directed through them.

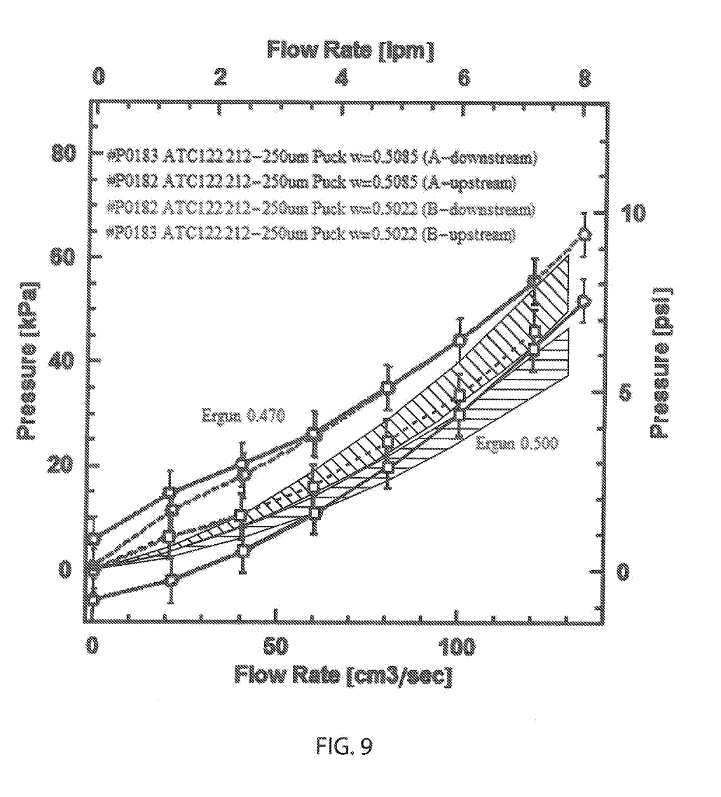

The widely-used Ergun-MacDonald correlation provides a prediction for the pressure drop versus steady-state flow rate through uniformly porous beds of spherical particles. Pressure drop as a function of flow rate was measured on the test beds above produced by Method III, and the results are shown in FIG. 9. The experimental data is overlayed with cross hatched bands that denote the Ergun-Macdonald prediction of pressure drop for the range of particle sizes used in the beds.

Referring to FIG. 9, steady state pressure drop versus flow rate for two beds constructed using the Method III is shown. Measured porosities are 50.2 and 50.9 percent respectively. These values are in close agreement with pressure prediction from the Ergun-Macdonald correlation for steady state flow in packed spherical beds.

The Ergun-Macdonald porosity value that provides the best fit to the data is 47 and 50 percent, respectively for Method III beds that have measured porosities of 50.2 and 50.9 percent. This close agreement over a wide range of flow rates indicates that the beds are free from large-scale channeling. It also indicates that the presence of epoxy necks in the beds are not significantly adding to the pressure drop (beyond their effect on the porosity). Additional studies have confirmed the agreement with the Ergun-Macdonald correlation within 2 to 3 percent over beds in the porosity range 40 to 60 percent. These results demonstrate that beds produced by Method III have a uniform porosity consistent with randomly arranged spheres without large-scale voids or channels.

### Example3

### Beds for an AMR

Twelve nominally identical beds for a magnetic refrigeration system using the AMR cycle were fabricated using Method I. Here, we provide further details of the fabrication process:
1. Each bed was composed of 6 layers of LaFeSiH. The Curie temperature of each layer was chosen to optimize the AMR performance over a desired temperature span using methods that are outside the scope of this invention. Each layer was formed from spherical particles that were sieved to obtain diameters between 178 and 246 microns.
2. The particles were cleaned by ultrasonic agitation in Alconox for 4 minutes. The fluid was decanted and the step was repeated with fresh Alconox. The fluid was decanted and the wet material was placed on filter paper, here it was rinsed with distilled water. The wet material was dislodged by rinsing with acetone into a clean beaker. The acetone was decanted and the beaker was re-filled with 20 ml of acetone. It was subjected to ultrasonic agitation for 4 minutes. The acetone was decanted and the wet material was placed on filter paper where it was rinsed with isopropanol. The material was dislodged from the filter paper using an isopropanol rinse into a clean beaker. The isopropanol was decanted and 20 ml of fresh isopropanol was added. It was then subjected to ultrasonic agitation for 4 minutes. The fluid is decanted and the material was then placed on filter paper and dried in an oven at 60 C for approximately 20 minutes. It was verified that the material was completely dry before proceeding to the next step.
3. For use in the system, the regenerators need to be enclosed in a metal (stainless steel) shell. The shell had a rectangular cross-section of 8 cm² with open ends and a length of 45 mm. The shell was cleaned ultrasonically with Alconox, acetone, and isopropanol in the same manner as the particles. The inner surface of the cleaned shell was coated with a thin layer of Hysol™ 9430 epoxy. A Delrin™ base was inserted into the bottom of the shell, forming a foundation upon which the porous layers of LaFeSiH could be constructed.
4. Hysol™ 9430 was used as the binding agent. The epoxy:particle mass ratio was 1.16%. The epoxy and dried particles were added to a plastic beaker and mixed with a wooden stick for 2 minutes forming a moldable porous mass. The moldable porous mass was placed on a glass slide and folded into the shell using a wooden stick. The material was distributed evenly in the shell using, the wooden stick. A Delrin™ plunger was inserted into the shell and used to compress the material to the desired height. This process was repeated for each subsequent layer until 6 layers had been constructed. During the layer formation, the successive use of the plunger tended to remove the epoxy coating from the inner surface of the shell. This coating was therefore periodically re-applied. A Delrin™ cap was then inserted into the top of the shell and the assembly was placed into an oven at 60 C for 24 hours.
5. The bed assembly was removed from the oven and allowed to cool. The Delrin™ base and cap were then removed. In previous testing on the effect of field cycling on similar beds, it was found that erosion of the bed began around the perimeter of each endface. To inhibit this erosion, a thin bead of Hysol™ 9430 epoxy was placed around the perimeter of each endface. The bed was then returned to the oven at 60 C for at least 8 hours to fully cure the bead of epoxy.

### Example 4

### Test Beds for an AMR Made Using Method IV

A set of test beds were fabricated using Method IV. These beds had an annular wedge cross-section of 14 cm² and a height of 7 mm. They were formed from 7 layers each 1 mm in thickness. These beds were intended to demonstrate the sharpness of the boundaries between thin layers. Therefore, the bed layers were formed from alternating materials with different colors so that the layer boundaries would be easily discernible. Here, we provide further details of the fabrication process:
1. The layers were made from alternating LaFeSi and copper spheres. The material was sieved to have diameters between 53 and 75 microns.
2. The material was cleaned in the same manner as in Example 3. The cleaned and dried material was then placed in metalized zipper bags and backfilled with dry nitrogen. The bags were then placed aside until the organosilane solution was prepared two days later.
3. The organosilane solution was prepared in the same manner as in Example 1. The particles were removed from the bag, rinsed with methanol to remove any trace water contamination, and then placed in the organosilane solution. The organosilane coating was applied to the particles in the same manner as in Example 1.
4. ResinLabs™ EP691 was used as the primary binding agent. The primary epoxy:particle mass ratio was 0.35%, derived from a desired total epoxy:particle mass ratio of 1.75% and a primary mass fraction off 20%. The epoxy and particles were thoroughly mixed in a plastic beaker for 2 minutes with a wooden stick. The mixture was then spread between two Teflon™ plates. The plates were compressed and moved back and forth relative to each other to produce a thin layer of approximately one particle diameter in thickness. The plates were pulled apart and placed in a fume hood without air circulation for 15 hours and 45 minutes. At this point, the material was tacky and was scraped off the plates with a razor blade.
5. Stycast™ 1266 was used as the secondary binding agent. The clusters formed above were mixed with this epoxy using a secondary mass fraction of 1−f=80%. The epoxy:particle mass ratio was therefore 0.8×1.75%=1.4%. The epoxy and clusters were gently mixed for 2 minutes using a wooden stick.
6. The mold for the beds consisted of 7 mold layers, each mold layer intended to produce a bed layer 1 mm in thickness. Each mold layer was formed from two pieces with thickness of 1 mm. The mold layer pieces were made from stainless steel with interior surfaces (the surfaces to be in contact with the moldable porous mass) coated with Teflon™. To form a mold layer, the two pieces were brought together forming a chamber with the desired cross-section and with height of 1 mm. The pieces were held in the proper position by aligning pins that were placed in an aluminum base. The base was covered with a thin Teflon™ sheet, which formed the foundation for the first layer. Once placed in the proper position against the aligning pins, the mold layer pieces were screwed down to the base to keep them flat.
7. The moldable porous mass from step 5 sufficient to give porosity of 50% was placed on a glass slide. The material was then folded into the mold layer using a wooden stick. A steel needle was used to draw the moldable porous mass into the edges of the form and ensure that the entire cross-section of the mold was filled. The needle was also used to evenly distribute the material and produce a uniform surface. The layer was then screeded using a wooden stick. This process produced a very smooth layer surface.
8. The assembly with the first layer was placed in an oven at 50 C for 45 minutes. While this was curing, the material for the next layer was prepared. The moldable porous mass for each layer was prepared in the same manner as described above.
9. After removal of the first layer assembly from the oven, the screws holding the first mold layer were removed but the first layer mold was left in place, held in the proper position by the aligning pins. The next mold layer, also composed of two separate pieces which are brought together to form a chamber, was assembled directly on top of the first mold layer. The pieces are also held in the proper position by the aligning pins. The new mold pieces were then fastened with screws to the base plate, compressing them flat against the previous mold layer.
10. Material is added to the next mold layer in the same manner as in step 7. The layer was screeded to form a very smooth surface.
11. These steps were repeated until 7 layers had been constructed. A Delrin™ cap was then clamped to the top of the assembly. The assembly was inverted and placed in an oven for 24 hours at 50 C.
12. The assembly was removed from the oven. The Delrin™ cap and the screws holding the last mold layer pieces were removed. The mold layer pieces and the solid epoxy-connected structure they contained were removed from the alignment pins. The mold layer pieces from each layer were then carefully separated, leaving a fully-cured, rigid, 7-layer bed with the desired shape.

The 7-layer bed fabricated above was inspected visually. The alternating LaFeSi (gray) and copper layer boundaries were clearly visible and found to be sharp and smooth. The structure was then placed in a plastic fixture which was filled with water with an anti-corrosion agent and a biocide. The fixture was then placed in a cycling magnetic field. Periodically, the fixture was taken out of the cycling field and inspected. After 2300 hours of this treatment, the structure showed no sign of degradation.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

### REFERENCES

The present method concerns cleaning of metallic particles via ultrasonic agitation, silane pretreatment, and construction of high porosity beds. Each of these references is hereby incorporated in its entirety by reference.

### GENERAL BACKGROUND

1. M. Kaviany, Principles of Heat Transfer in Porous Media, Springer, 2nd edition (1995).
2. E. M. Petrie, Epoxy Adhesive Formulations, McGraw Hill (2006).
3. S. Jacobs. “Modeling and optimal design of a multilayer active magnetic refrigeration system”, Proc. 3^{rd} Int. Conf. on Mag. Refrig. at Room Temp., pgs. 267-273 (2009).
4. S. Jacobs, J. Auringer, A. Boeder, J. Chell, L. Komorowski, J. Leonard, S. Russek, and C. Zimm, “Performance of a Large-Scale Rotary Magnetic Refrigerator”, Proceedings of the 5^{th} International Conference on Magnetic Refrigeration at Room Temperature, September 2012.

### BACKGROUND ON COATINGS

5. J. A. J. Schutyser, C. A. M. Vijverberg, “Coated particles and coating compositions comprising coated particles”, Nupley, Resins BV EP 1874875 A1 (2006).
6. A. Lejeune, Y. Gentil, “Epoxy silane oligomer and coating composition containing same”, Momentive Performance Materials Inc. EP 1896522 B1 (2006).
7. J. Besinger, A. Steinberg, C. Zimmerer, “Powder particles that are uniformly coated with functional groups, method for their production and use thereof”, Schott A G U.S. Pat. No. 8,349,399 B2 (2005).
8. S. E. Remmert, D. L. Ketterer, “Corrosion and UV resistant article and process for coating the article”, Eaton Corp. EP 1277522 A2 (2002).
9. K. D. Weiss, J. Carlson, D. A. “Magnetorheological materials utilizing surface-modified particles”, Lord Corp. EP 0672294 B1 (1993).

### BACKGROUND ON BEDS

10. Y. Ishizaki “Sheet-type regenerative heat exchanger”, ECTI/Fukuda Metal Foil & Powder Ltd. US 20020139510 A1 (2001).
11. K. Hashimoto, M. Okamura, T. Arai, “Cold accumulating material and cold accumulating refrigerator using the same”, Toshiba Corp. U.S. Pat. No. 6,363,727 B1 (1999).
12. M. Okamura, T. Arai, K. Hashimoto, R, Chandrtilleke, H. Nakagome, “Cold accumulation material for ultra-low temperature, refrigerating machine”, Toshiba Corp. EP 0870814 A1. (1997)
13. A. J. Barclay, R. W. Merida-Donis, “Thermal regenerators and fabrication methods for thermal regenerators” (abandoned), University of Victoria WO 1998028585 A1 (1997).
14. A. Saito, M. Sahashi, Y. Tokai, A. Tsutai, M. Okamura, Y. Nishiyama, M. Inaba, “Regenerating material and refrigerator using the same”, Toshiba Corp. U.S. Pat. No. 5,593,517 A (1993).
15. J. C. Shain, A. D. Haines, “Encapsulated oxidation-resistant permanent magnet particles”, General Motors Corp. EP 0561445 A1 (1993).
16. J. A. Barclay, W. A. Steyert, “Active Magnetic Refrigerator”, US Dept. Energy U.S. Pat. No. 4,332,135 A (1981).

We claim:

1. A method of fabricating a thermal regenerator having one or more layers comprising the following steps:
(a) mixing a plurality of magnetocaloric particles and a binding agent to form a moldable porous mass;
(b) transferring a predetermined weight of the moldable porous mass to a mold;
(c) distributing the moldable porous mass to fill a cross-section of the mold such that the moldable porous mass extends to a substantially constant predetermined height within the mold defining a desired volume to form a layer;
(d) mixing a second plurality of magnetocaloric particles, distinct from the first plurality of magnetocaloric particles, and a binding agent to form a second moldable porous mass;
(e) repeating steps (b)-(e) with a second predetermined weight of the second moldable porous mass distributed to extend to a second substantially constant desired height within the mold defining a second predetermined volume; and
(e) allowing the binding agent to harden within the mold to form a hardened mass.

2. The method of claim 1 further comprising the following steps which precede step (a):
agitating the plurality of magnetocaloric particles while in contact with an aqueous detergent solution;
filtering the aqueous detergent solution from the particles; and
rinsing and filtering the aqueous detergent solution from the particles.

3. The method of claim 1 further comprising the following steps which precede step (a):
agitating the plurality of magnetocaloric particles while in contact with a non-aqueous solvent;
filtering the non-aqueous solvent from the particles; and
rinsing and filtering the non-aqueous solvent from the particles.

4. The method of claim 1 further comprising the step of applying an organosilane film to the plurality of particles before step (a).

5. The method of claim 1 further comprising the following steps between step (a) and step (b):
forming clusters of particles from the moldable porous mass; and
collecting the clusters of particles and adding secondary binding agent to form a new moldable mass.

6. The method of claim 5 further comprising the following steps which precede step (a):
agitating the plurality of magnetocaloric particles while in contact with an aqueous detergent solution;
filtering the aqueous detergent solution from the particles; and
rinsing and filtering the aqueous detergent solution from the particles.

7. The method of claim 5 further comprising the following steps which precede step (a):
agitating the plurality of magnetocaloric particles while in contact with a non-aqueous solvent;
filtering the non-aqueous solvent from the particles; and
rinsing and filtering the non-aqueous solvent from the particles.

8. The method of claim 5 further comprising the step of applying an organosilane film to the plurality of particles before step (a).

9. A method of fabricating a thermal regenerator having one or more layers which includes the steps of:
(a) mixing a plurality of magnetocaloric particles and a primary binding agent to form a porous mass;
(b) forming clusters of particles from the porous mass and at least partially curing the clusters; and
(c) collecting the partially cured clusters of particles and adding a secondary binding agent into a larger mass to form a new porous mass.
